(19) United States
(12) Patent Application Publication
(10) Pub. No.: US 2025/0222387 A1
(43) Pub. Date: Jul. 10, 2025

(54) AIR PURIFIER INCLUDING PLURALITY OF BLADES AND AIR SUCTION METHOD THEREOF

(71) Applicant: SAMSUNUNG ELECTRONICS CO., LTD., Suwon-si (KR)

(72) Inventors: Jeimin CHOI, Suwon-si (KR); Hyunkook KIM, Suwon-si (KR); Keunjeong JANG, Suwon-si (KR)

(73) Assignee: SAMSUNG ELECTRONICS CO., LTD., Suwon-si (KR)

(21) Appl. No.: 19/090,006

(22) Filed: Mar. 25, 2025

Related U.S. Application Data
(63) Continuation of application No. PCT/KR2023/014250, filed on Sep. 20, 2023.

(30) Foreign Application Priority Data
Oct. 27, 2022 (KR) 10-2022-0140282

(51) Int. Cl. B01D 46/46; B01D 46/00; B01D 46/62

(52) U.S. Cl. CPC B01D 46/46; B01D 46/0038; B01D 46/0045; B01D 46/62; B01D 2273/28; B01D 2273/30

(57) ABSTRACT

An air purifier includes: a main body including a suction port; a fan in the main body and configured to form a flow of air for air to be suctioned through the suction port; a plurality of blades configured to guide an air flow direction of the air suctioned through the suction port; and one or more processors configured to: identify a surrounding environment of the air purifier based on an operation state of the air purifier; and control the plurality of blades based on the surrounding environment.

### CROSS-REFERENCE TO RELATED APPLICATIONS

This application is a continuation of International Application No. PCT/KR2023/014250, filed on Sep. 20, 2023, which is based on and claims priority to Korean Patent Application No. 10-2022-0140282, filed on Oct. 27, 2022, in the Korean Intellectual Property Office, the disclosures of which are incorporated by reference herein in their entireties.

### BACKGROUND

### 1. Field

The disclosure relates to an air purifier including a plurality of blades and an air suction method thereof.

### 2. Description of Related Art

Air purifiers are installed in various location such as homes, offices, shops, and the like.

An air purifier may be a device that purifies air by removing dust and the like in air. That is, the air purifier suctions air, remove dust and the like in the suctioned air using a filter, and discharge purified air.

### SUMMARY

According to an aspect of the disclosure, an air purifier includes: a main body including a suction port; a fan in the main body and configured to form a flow of air for air to be suctioned through the suction port; a plurality of blades configured to guide an air flow direction of the air suctioned through the suction port; and one or more processors configured to: identify a surrounding environment of the air purifier based on an operation state of the air purifier; and control the plurality of blades based on the surrounding environment.

The air purifier may further include a motor configured to drive the fan. The operation state of the air purifier may include at least one of a rotation speed of the fan, a power consumption of the, or an input current of the motor.

The one or more processors may be further configured to identify the surrounding environment of the air purifier based on a rate of change of a current operation state of the air purifier with respect to a previous operation state of the air purifier.

The one or more processors may be further configured to identify, based on a rate of change of a current rotation speed with respect to a previous rotation speed of the fan being less than or equal to a first value, that an object is present in the surrounding environment of the air purifier; identify, based on the rate of change of the current rotation speed with respect to the previous rotation speed of the fan being greater than the first value and less than or equal to a second value, that the air purifier is present in a same surrounding environment as a previous surrounding environment; and identify, based on the rate of change of the current rotation speed with respect to the previous rotation speed of the fan being greater than the second value, that the object is absent in the surrounding environment of the air purifier.

The one or more processors may be further configured to identify, based on a rate of change of a current power consumption with respect to a previous power consumption of the motor being less than or equal to a first value, that an object is absent in the surrounding environment of the air purifier; identify, based on the rate of change of the current power consumption with respect to the previous power consumption of the motor being greater than the first value and less than or equal to a second value, that the air purifier is present in a same surrounding environment as a previous surrounding environment; and identify, based on the rate of change of the current power consumption with respect to the previous power consumption of the motor being greater than the second value, that the object is present in the surrounding environment of the air purifier.

The one or more processors may be further configured to identify, based on a rate of change of a current input current with respect to a previous input current of the motor being less than or equal to a first value, that an object is absent in the surrounding environment of the air purifier; identify, based on the rate of change of the current input current with respect to the previous input current of the motor being greater than the first value and less than or equal to a second value, that the air purifier is present in a same surrounding environment as a previous surrounding environment; and identify, based on the rate of change of the current input current with respect to the previous input current of the motor being greater than the second value, that the object is present in the surrounding environment of the air purifier.

The one or more processors may be further configured to identify a suction mode of the air purifier among a plurality of suction modes based on the surrounding environment; and control the plurality of blades based on the suction mode. A rotation angle of the plurality of blades may be based on the suction mode of the air purifier.

The one or more processors may be further configured to identify, based on an object being identified as absent in the surrounding environment of the air purifier based on the operation state of the air purifier, that the suction mode of the air purifier is a basic suction mode; and rotate the plurality of blades by 90° based on the basic suction mode.

The one or more processors may be further configured to control, based on the air purifier being identified as present in a same surrounding environment as a previous surrounding environment based on the operation state of the air purifier, the air purifier to operate a same suction mode as a previous suction mode of the air purifier.

The one or more processors may be further configured to control, based on an object being identified as present in a surrounding environment of the air purifier based on the operation state of the air purifier, the air purifier to operate in each of the plurality of suction modes; identify a power consumption of a motor that drives the fan while the air purifier is being driven in each of the plurality of suction modes; identify a suction mode having a lowest power consumption from among the plurality of suction modes as the suction mode of the air purifier based on the power consumption; and control the plurality of blades based on the suction mode. The plurality of suction modes may include a left suction mode, a right suction mode, a left and right suction mode, and a swing suction mode.

According to another aspect of the present disclosure, an air suction method of an air purifier includes: driving a fan to form an airflow for air to be suctioned through a suction port at a main body of the air purifier; identifying a surrounding environment of the air purifier based on an operation state of the air purifier; and controlling a plurality of blades to guide an air flow direction of the airflow through the suction port based on the surrounding environment.

The operation state of the air purifier may include at least one of a rotation speed of the fan, a power consumption of a motor that drives the fan, or an input current of the motor.

The identifying the surrounding environment of the air purifier may include identifying the surrounding environment of the air purifier based on a rate of change of a current operation state of the air purifier with respect to a previous operation state of the air purifier.

The identifying the surrounding environment of the air purifier may include: identifying, based on a rate of change of a current rotation speed with respect to a previous rotation speed of the fan being less than or equal to a first value, that an object is present in the surrounding environment of the air purifier; identifying, based on the rate of change of the current rotation speed with respect to the previous rotation speed of the fan being greater than the first value and less than or equal to a second value, that the air purifier is present in a same surrounding environment as a previous surrounding environment; and identifying, based on the rate of change of the current rotation speed with respect to the previous rotation speed of the fan being greater than the second value, that the object is absent in the surrounding environment of the air purifier.

The identifying the surrounding environment of the air purifier may include: identifying, based on a rate of change of a current power consumption with respect to a previous power consumption of the motor being less than or equal to a first value, that an object is absent in the surrounding environment of the air purifier; identifying, based on the rate of change of the current power consumption with respect to the previous power consumption of the motor being greater than the first value and less than or equal to a second value, that the air purifier is present in a same surrounding environment as a previous surrounding environment; and identifying, based on the rate of change of the current power consumption with respect to the previous power consumption of the motor being greater than the second value, that the object is present in the surrounding environment of the air purifier.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A, FIG. 1B, and FIG. 1C are diagrams illustrating an air purifier according to various embodiments of the disclosure;

FIG. 2 is a block diagram illustrating a configuration of an air purifier according to various embodiments of the disclosure;

FIG. 3A, FIG. 3B, FIG. 3C, FIG. 3D, and FIG. 3E are diagrams illustrating states of a plurality of blades based on suction modes according to various embodiments of the disclosure;

FIG. 4, FIG. 5A, FIG. 5B, and FIG. 6 are diagrams illustrating a method in which an air purifier operates based on the surrounding environment according to various embodiments of the disclosure;

FIG. 7 is a block diagram illustrating a detailed configuration of an air purifier according to various embodiments of the disclosure;

FIG. 8 is a flowchart illustrating an air suction method of an air purifier according to various embodiments of the disclosure;

FIG. 9 is a flowchart illustrating an air suction method of an air purifier according to various embodiments of the disclosure; and

FIG. 10 is a diagram illustrating a notification being provided from an air purifier according to various embodiments of the disclosure.

### DETAILED DESCRIPTION

Various modifications may be made to the embodiments of the disclosure, and there may be various types of embodiments. Accordingly, specific embodiments will be illustrated in drawings, and described in detail in the detailed description. However, it should be noted that the various embodiments are not for limiting the scope of the disclosure to a specific embodiment, but they should be interpreted to include all modifications, equivalents or alternatives of the embodiments included in the ideas and the technical scopes disclosed herein. With respect to the description of the drawings, like reference numerals may be used to indicate like elements.

In describing the disclosure, in case it is determined that the detailed description of related known technologies may unnecessarily confuse the gist of the disclosure, the detailed description thereof will be omitted.

Further, the embodiments below may be modified to various different forms, and it is to be understood that the scope of the technical spirit of the disclosure is not limited to the embodiments below. Rather, the embodiments are provided so that the disclosure will be thorough and complete, and to fully convey the technical spirit of the disclosure to those skilled in the art.

Terms used in the disclosure have been merely used to describe a specific embodiment, and is not intended to limit the scope of protection. A singular expression includes a plural expression, unless otherwise specified.

In the disclosure, expressions such as “have”, “may have”, “include”, and “may include” are used to designate a presence of a corresponding characteristic (e.g., elements such as numerical value, function, operation, or component), and not to preclude a presence or a possibility of additional characteristics.

Throughout the disclosure, the expression “at least one of a, b or c” indicates only a, only b, only c, both a and b, both a and c, both b and c, all of a, b, and c, or variations thereof.

Expressions such as “1st”, “2nd”, “first” or “second” used in the disclosure may limit various elements regardless of order and/or importance, and may be used merely to distinguish one element from another element and not limit the relevant element.

When a certain element (e.g., a first element) is indicated as being “(operatively or communicatively) coupled with/to” or “connected to” another element (e.g., a second element), it may be understood as the certain element being directly coupled with/to the another element or as being coupled through other element (e.g., a third element).

Conversely, when a certain element (e.g., first element) is indicated as “directly coupled with/to” or “directly connected to” another element (e.g., second element), it may be understood as the other element (e.g., third element) not being present between the certain element and the another element.

The expression “configured to . . . (or set up to)” used in the disclosure may be used interchangeably with, for example, “suitable for . . . ”, “having the capacity to . . . ”, “designed to . . . ”, “adapted to . . . ”, “made to . . . ”, or “capable of . . . ” based on circumstance. The term “configured to . . . (or set up to)” may not necessarily mean “specifically designed to” in terms of hardware.

Rather, in a certain circumstance, the expression “a device configured to . . . ” may mean something that the device “may perform . . . ” together with another device or components. For example, a phrase “a processor configured to (or set up to) perform A, B, or C” may mean a dedicated processor for performing a relevant operation (e.g., an embedded processor), or a generic-purpose processor (e.g., a central processing unit (CPU) or an application processor) capable of performing the relevant operations by executing one or more software programs stored in a memory device.

The term ‘module’ or ‘part’ used in one or more embodiments herein perform at least one function or operation, and may be implemented with a hardware or software, or implemented with a combination of hardware and software. In addition, a plurality of ‘modules’ or a plurality of ‘parts’, except for a ‘module’ or a ‘part’ which needs to be implemented with a specific hardware, may be integrated in at least one module and implemented as at least one processor.

Various elements and areas of the drawings have been schematically illustrated. Accordingly, the technical spirit of the disclosure is not limited by relative sizes and distances illustrated in the accompanied drawings.

Embodiments of the disclosure will be described in detail with reference to the accompanying drawings to aid in the understanding of those of ordinary skill in the art.

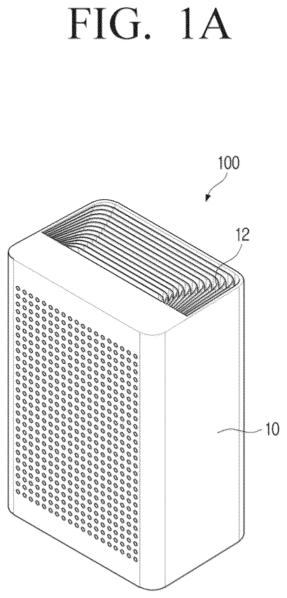

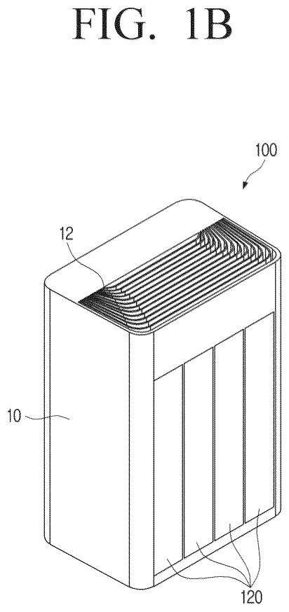

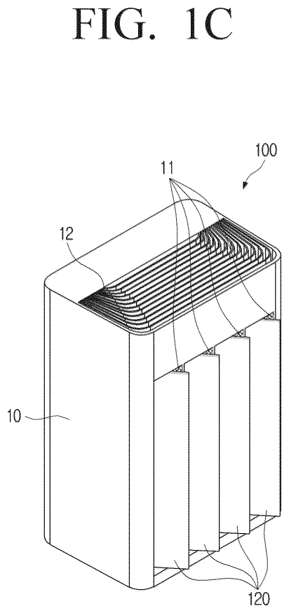

FIG. 1A, FIG. 1B, and FIG. 1C are diagrams illustrating an air purifier according to various embodiments of the disclosure.

Referring to FIG. 1A, FIG. 1B, and FIG. 1C, an air purifier 100 may include a main body 10 which forms an exterior of the air purifier 100. In this case, the main body 10 may be in a rectangular parallelepiped shape. However, the shape is not limited to this example, and the main body 10 may have various shapes such as a cube shape or a circular shape.

Suction ports 11 may be formed on the main body 10 to suction air. For example, the suction ports 11 may be formed at a back surface of the main body 10. In addition, discharge ports 12 may be formed for air to be discharged at the main body 10. For example, the discharge ports 12 may be formed at a top surface of the main body 10.

The air purifier 100 may remove dust and the like in air, and purify the air.

Specifically, the air purifier 100 may circulate air by driving a fan (i.e., a blowing fan), and remove dust and the like in air through a filter positioned on a flow path of air.

For example, the air purifier may suction, by driving the fan, air through the suction ports 11, remove dust and the like included in the suctioned air using the filter, and discharge purified air through the discharge ports 12.

In this case, the filter may include a pre-filter and a dust collecting filter. Accordingly, dust may be removed from air that passed through the filter, and the purified air may be discharged through the discharge ports 12. In addition, the filter may further include a deodorizing filter. In this case, the deodorizing filter may be disposed between the pre-filter and the dust collecting filter, and odor particles included in air may be removed (e.g., harmful gases such as formaldehyde, ammonia, acetic acid, etc.).

The air purifier 100 may include a plurality of blades 120 (blade part). Referring to FIG. 1B and FIG. 1C, each of the plurality of blades 120 may be in a bar shape. However, the above is merely one example, and the blades may have various shapes.

In addition, the plurality of blades 120 may open and close the suction ports 11 by being rotatably coupled to the main body 10. For example, if the plurality of blades 120 is closed, the suction ports 11 may be closed. Further, if the plurality of blades 120 is opened according to rotation thereof, a plurality of openings may be formed by the plurality of blades 120. Accordingly, the suction ports 11 may be exposed through the plurality of openings, and air may be suctioned inside the air purifier 100 through the suction ports 11.

The air purifier 100 may identify a surrounding environment of the air purifier 100, and drive the plurality of blades 120 so the plurality of blades 120 rotate according to the surrounding environment. Accordingly, based on the air purifier 100 being able to effectively suction indoor air according to the surrounding environment, the indoor air may be quickly and uniformly purified.

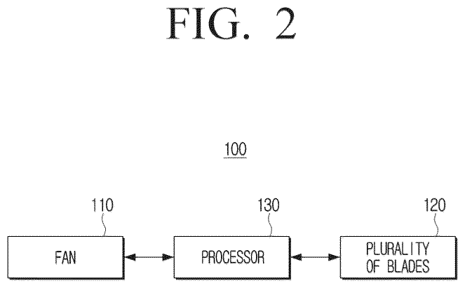

FIG. 2 is a block diagram illustrating a configuration of an air purifier according to various embodiments of the disclosure.

Referring to FIG. 2, the air purifier 100 may include a fan 110, the plurality of blades 120, and one or more processors 130.

The fan 110 may form a flow of air and suction the air through the suction ports 11 formed at the main body 10 of the air purifier 100.

To this end, the air purifier 100 may include a motor for driving the fan 110. The fan 110 may rotate receiving rotational force from the motor, and when the fan 110 is rotated, a flow of air may be generated. Accordingly, air may be suctioned through the suction ports 11 formed at the main body 10. In this case, the dust in the suctioned air may be removed by the filter, and purified air maybe discharged through the discharge ports 12 formed at the main body 10. To this end, the air purifier 100 may further include a duct, and air that passed through the filter may be discharged to the discharge ports 12 flowing along the duct.

As described, the fan 110 may suction air to the air purifier 100, and discharge the suctioned air to the outside.

The plurality of blades 120 may open and close the suction ports 11 by being rotatably coupled to the main body 10. To this end, the air purifier 100 may include a plurality of motors (e.g., a plurality of step motors) for rotating the plurality of blades 120. In this case, the motors may rotate the blades. Alternatively, first motors may rotate a portion of the blades from among the plurality of blades, and second motors may rotate the remaining blades from among the plurality of blades.

The plurality of blades 120 may guide an air flow direction suctioned through the suction ports 11.

Specifically, if the fan 110 is rotated, air may be suctioned inside the air purifier 100 through the plurality of openings formed by the plurality of blades 120. Accordingly, a suctioned air flow of air may be controlled according to a direction to which the plurality of openings is facing.

To this end, the air purifier 100 may operate (or drive) in one suction mode from among a plurality of suction modes. Based on a rotation angle of the plurality of blades 120 varying according to the suction mode, a suction air flow direction may be controlled according to the suction mode.

For example, the plurality of suction modes may include a basic suction mode, a right suction mode, a left suction mode, a left and right suction mode, and a swing suction mode.

It may be assumed that the plurality of blades 120 is rotated in a clockwise direction below.

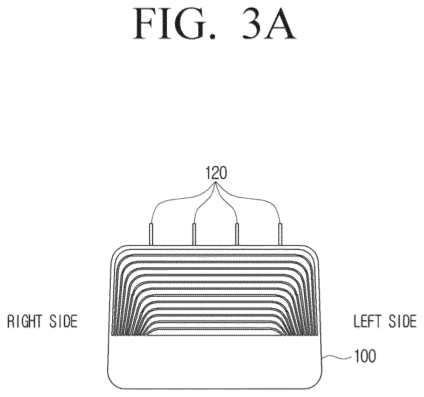

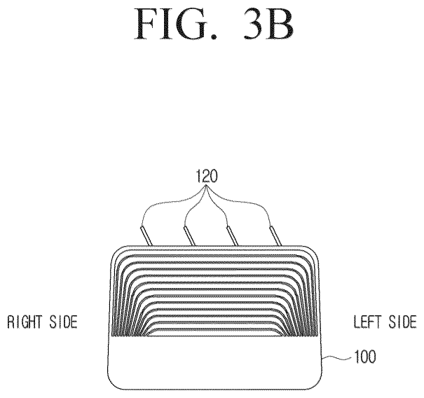

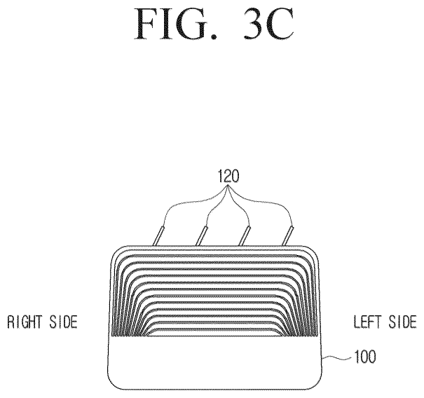

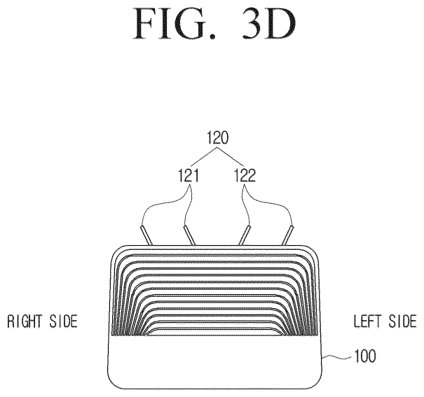

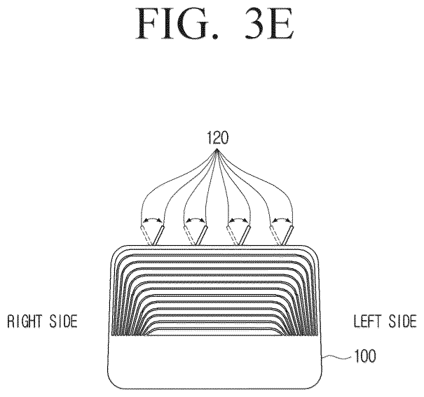

In an example, as in FIG. 3A, the plurality of blades 120 in the basic suction mode may be rotated by 90°.

In an example, the right suction mode may be a mode for increasing suction amount of external air for a right direction of the air purifier 100. In this case, as in FIG. 3B, the plurality of blades 120 in the right suction mode may be rotated by θ₁°. Here, θ₁ may be greater than 0 and less than 90 (0<θ₁<90; for example, θ₁=45). Accordingly, the plurality of openings formed by the plurality of blades 120 may face a right direction of the air purifier 100. Further, the suction amount of external air for the right direction of the air purifier 100 may be increased.

In an example, the left suction mode may be a mode for increasing the suction amount of external air for a left direction of the air purifier 100. In this case, as in FIG. 3C, the plurality of blades 120 in the left suction mode may be rotated by θ₂°. Here, θ₂ may be greater than 90 and less than 180 (90<θ₂<180; for example, θ₂=135). Accordingly, the plurality of openings formed by the plurality of blades 120 may face a left direction of the air purifier 100. Further, the suction amount of external air for the left direction of the air purifier 100 may be increased.

In an example, the left and right suction mode may be a mode for increasing the suction amount of external air for the left and right directions of the air purifier 100. In this case, as in FIG. 3D, a portion of the blades 121 in the left and right suction mode may be rotated by θ₁°, and the remaining blades 122 may be rotated by θ₂°. Here, the portion of the blades 121 may be blades positioned at a left side of the plurality of blades 120, the remaining blades 122 may be blades positioned at a right side of the plurality of blades 120, and a number of the portion of the blades 121 and a number of remaining blades 122 may be the same. Further, θ₁ may be greater than 0 and less than 90 (0<θ₁<90; for example, θ₁=45), and θ₂ may be greater than 90 and less than 180 (90<θ₂<180; for example, θ₂=135). Accordingly, a portion of the openings from among the plurality of openings formed by the plurality of blades 120 may face the right direction of the air purifier 100, and the remaining openings may face the left direction of the air purifier 100. Further, suction amounts of external air for the left and right directions of the air purifier 100 may be increased.

In an example, the swing suction mode may be a mode in which the plurality of blades 120 rotates left and right as in FIG. 3E. Accordingly, the plurality of openings formed by the plurality of blades 120 may face the left and right directions according to a rotation of the plurality of blades 120. Further, the suction amounts of external air for the left and right directions of the air purifier 100 may be increased.

Although the plurality of blades 120 has been described as being rotated in the clockwise direction in the above-described example, this is merely one example. That is, the plurality of blades 120 may rotate in an anti-clockwise direction, and θ₁ and θ₂ may be determined accordingly.

One or more processors 130 may control the overall operation and functions of the air purifier 100.

The one or more processors 130 may include one or more from among a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The one or more processors 130 may control one or a random combination from among other elements of the air purifier 100, and perform an operation associated with communication or data processing. The one or more processors 130 may execute one or more programs or instructions stored in a memory. For example, the one or more processors 130 may perform, by executing one or more instructions stored in the memory, a method according to various embodiments of the disclosure.

When a method according to various embodiments of the disclosure includes a plurality of operations, the plurality of operations may be performed by one processor, or performed by a plurality of processors. For example, when a first operation, a second operation, and a third operation are performed by a method according to various embodiments, the first operation, the second operation, and the third operation may all be performed by a first processor, or the first operation and the second operation may be performed by the first processor (e.g., a generic-purpose processor) and the third operation may be performed by a second processor (e.g., an artificial intelligence dedicated processor).

The one or more processors 130 may be implemented as a single core processor that includes one core, or implemented as one or more multicore processors that include a plurality of cores (e.g., a homogeneous multicore or a heterogeneous multicore). If the one or more processors 130 are implemented as multicore processors, each of the plurality of cores included in the multicore processors may include a memory inside the processor such as a cache memory and an on-chip memory, and a common cache shared by the plurality of cores may be included in the multicore processors. In addition, each of the plurality of cores (or a portion from among the plurality of cores) included in the multicore processors may independently read and perform a program command for implementing a method according to various embodiments of the disclosure, or read and perform a program command for implementing a method according to various embodiments of the disclosure due to a whole (or a portion) of the plurality of cores being interconnected.

When a method according to various embodiments of the disclosure includes a plurality of operations, the plurality of operations may be performed by one core from among the plurality of cores or performed by the plurality of cores included in the multicore processors. For example, when a first operation, a second operation, and a third operation are performed by a method according to various embodiments, the first operation, the second operation, and the third operation may all be performed by a first core included in the multicore processors, or the first operation and the second operation may be performed by the first core included in the multicore processors and the third operation may be performed by a second core included in the multicore processors.

In the embodiments of the disclosure, the processor may refer to a system on chip (SoC), a single core processor, or multicore processors in which the one or more processors and other electronic components are integrated or a core included in the single core processor or the multicore processors, and the core herein may be implemented as the CPU, the GPU, the APU, the MIC, the DSP, the NPU, the hardware accelerator, the machine learning accelerator, or the like, but embodiments are not limited thereto. However, for convenience of description, an operation of the air purifier 100 will be described below using the expression ‘processor 120.’

The one or more processors 130 will be described as the processor 130 below.

The processor 130 may drive the fan 110. In this case, the processor 130 may rotate the fan 110 by driving the motor. In addition, the processor 130 may rotate the plurality of blades 120. In this case, the processor 130 may rotate the plurality of blades 120 by driving the plurality of motors.

The processor 130 may identify a surrounding environment of the air purifier 100 based on an operation state of the air purifier 100.

Here, the operation state of the air purifier 100 may include at least one from among a rotation speed of the fan 110, power consumption of the motor that drives the fan 110, and input current of the motor that drives the fan 110.

Further, the surrounding environment of the air purifier 100 may include at least one of whether an environment in which the air purifier 100 is positioned has changed, whether the environment has changed, or whether an object is present in the surrounding of the air purifier 100. Here, the object may be various objects that may be present in a space in which the air purifier 100 is positioned such as a wall, a door, and a home appliance.

Specifically, the processor 130 may identify the surrounding environment of the air purifier 100 based on a rate of change of a current operation state of the air purifier 100 with respect to a previous operation state of the air purifier 100.

To this end, information about the previous operation state of the air purifier 100 may be stored in a memory of the air purifier 100.

Specifically, the processor 130 may cause the motor to drive the fan 110 to suction, based on a user input for driving the air purifier 100 being received (e.g., a user input for turning-on the air purifier 100), air inside the air purifier 100. In this case, the processor 130 may rotate the plurality of blades 120 by 90°. That is, the processor 130 may drive the air purifier 100 in the basic suction mode.

Further, the processor 130 may obtain information about at least one from among the rotation speed of the fan 110 while the fan 110 is being driven, the power consumption of the motor that drives the fan 110, and the input current of the motor that drives the fan 110. To this end, the air purifier 100 may include a sensor for measuring the rotation speed of the fan 110, and the power consumption and input current of the motor.

In this case, the processor 130 may measure the rotation speed of the fan 110, and the power consumption and input current of the motor using the sensor. For example, the processor 130 may measure the rotation speed of the fan 110 by applying Vsp voltage (i.e., voltage for controlling motor rotation speed to control a rotation speed of the motor) to the motor for driving the fan 110. In addition, the processor 130 may measure the power consumption and input current of the motor for driving the fan 110. In this case, the processor 130 may measure the rotation speed of the fan 110, and the power consumption and input current of the motor for a pre-set time from a time-point at which the fan 110 is driven (e.g., time of 5 minutes after the fan 110 is driven).

Further, the processor 130 may store the obtained information in the memory.

As described, the processor 130 may drive, based on the user input for driving the air purifier 100 being received, the air purifier 100 in the basic suction mode, and measure the rotation speed of the fan 110, and the power consumption and input current of the motor.

The processor 130 may obtain, based on the fan 110 being driven again (e.g., based on power of the air purifier 100, in which the power was turned-off, being turned-on again), information about at least one from among the rotation speed of the fan 110 while the fan 110 is being driven, the power consumption of the motor that drives the fan 110, or the input current of the motor that drives the fan 110. The methods of measuring the rotation speed of the fan 110, the power consumption of the motor, and the input current of the motor may be the same as described above. That is, the processor 130 may drive the air purifier 100 in the basic suction mode, and measure the rotation speed of the fan 110, and the power consumption and input current of the motor while the air purifier 100 is being driven in the basic suction mode.

Further, the processor 130 may compare the obtained information with the information stored in the memory, and identify the rate of change of the current operation state of the air purifier 100 with respect to the previous operation state of the air purifier 100. In addition, the processor 130 may store the obtained information in the memory, and update the information about the operation state of the air purifier stored in the memory.

Specifically, the processor 130 may identify a rate of change of a current rotation speed with respect to a previous rotation speed of the fan 110. In this case, the rate of change may be calculated as (s₂/s₁)×100%. Here, s₁ may be the previous rotation speed of the fan 110, and s₂ may be the current rotation speed of the fan 110.

Here, the processor 130 may identify, based on the rate of change of the current rotation speed with respect to the previous rotation speed of the fan 110 being less than or equal to a first value, that an object is present in the surrounding environment of the air purifier 100. In addition, the processor 130 may identify, based on the rate of change of the current rotation speed with respect to the previous rotation speed of the fan 110 being greater than the first value and less than or equal to a second value, that the air purifier 100 is present in the same surrounding environment as a previous surrounding environment. In addition, the processor 130 may identify, based on the rate of change of the current rotation speed with respect to the previous rotation speed of the fan 110 being greater than the second value, that the object is not present (i.e. absent) in the surrounding environment of the air purifier 100.

In addition, the processor 130 may identify a rate of change of a current power consumption with respect to a previous power consumption of the motor that drives the fan 110. In this case, the rate of change may be calculated as (w₂/w₁)×100%. Here, w₁ may be the previous power consumption of the motor, and w₂ may be the current power consumption of the motor.

Here, the processor 130 may identify, based on the rate of change of the current power consumption with respect to the previous power consumption of the motor being less than or equal to a first value, that an object is not present (i.e. absent) in the surrounding environment of the air purifier 100. In addition, the processor 130 may identify, based on the rate of change of the current power consumption with respect to the previous power consumption of the motor being greater than the first value and less than or equal to a second value, that the air purifier 100 is present in the same surrounding environment as a previous surrounding environment. In addition, the processor 130 may identify, based on the rate of change of the current power consumption with respect to the previous power consumption of the motor being greater than the second value, that the object is present in the surrounding environment of the air purifier 100.

In addition, the processor 130 may identify a rate of change of a current input current with respect to a previous input current of the motor that drives the fan 110. In this case, the rate of change may be calculated as (i₂/i₁)×100%. Here, i₁ may be the previous input current of the motor, and i₂ may be the current input current of the motor.

Here, the processor 130 may identify, based on the rate of change of the current input current with respect to the previous input current of the motor being less than or equal to a first value, that an object is not present (i.e. absent) in the surrounding environment of the air purifier 100. In addition, the processor 130 may identify, based on the rate of change of the current input current with respect to the previous input current of the motor being greater than the first value and less than or equal to a second value, that the air purifier 100 is present in the same surrounding environment as a previous surrounding environment. In addition, the processor 130 may identify, based on the rate of change of the current input current with respect to the previous input current of the motor being greater than the second value, that the object is present in the surrounding environment of the air purifier 100.

In the above-described examples, the first value may be 95%, and the second value may be 105%. However, the above is merely one example, and the first and second values may be various values.

That is, it may be assumed that a home appliance is installed in the surrounding of the air purifier 100 or that the air purifier 100 is moved near the wall or the home appliance. In this case, objects such as the wall or the home appliance may act as suction resistance to the air purifier 100, and interfere with the suctioning of air by the air purifier 100. Accordingly, the rotation speed of the fan 110 may be reduced compared to when there was no suction resistance, and the power consumption and input current of the motor may be increased compared to when there was no suction resistance. Accordingly, the processor 130 may identify, when the rotation speed of the fan 110 is reduced compared to previously, or if the power consumption or input current of the motor is increased compared to previously, that the surrounding environment of the air purifier 100 has changed and that an object is not present in the surrounding of the current air purifier 100.

Conversely, it may be assumed that a home appliance which was present near the air purifier 100 is moved to another position, or that the air purifier 100 is moved to a position where there is no wall or home appliance nearby. In this case, the suction resistance in the surrounding of the air purifier 100 is regarded as disappeared. Accordingly, the rotation speed of the fan 110 may be increased compared to when the suction resistance was present, and the power consumption and input current of the motor may be reduced compared to when the suction resistance was present. Accordingly, the processor 130 may identify, when the rotation speed of the fan 110 is increased compared to previously, or when the power consumption and input current of the motor are reduced compared to previously, that the surrounding environment of the air purifier 100 has changed and that an object is not present in the surrounding of the current air purifier 100.

The processor 130 may identify, based on the rotation speed of the fan 110, and the power consumption and input current of the motor being the same as previously, or a difference with the previous not being greater than or equal to a pre-set value, that the air purifier 100 is present in the same environment as previously.

Further, the processor 130 may control the plurality of blades 120 based on the identified surrounding environment.

Specifically, the processor 130 may suction air inside the air purifier 100 by driving the fan 110. In addition, the processor 130 may identify that the suction mode of the air purifier 100 is one suction mode from among the plurality of suction modes based on the identified surrounding environment, and control the plurality of blades 120 based on the identified suction mode. In this case, the rotation angle of the plurality of blades 120 may be determined according to the suction mode of the air purifier 100. Accordingly, the suction air flow of air being suctioned to the air purifier 100 may be controlled.

Here, the plurality of suction modes may include the basic suction mode, the right suction mode, the left suction mode, the left and right suction mode, and the swing suction mode.

In an example, the processor 130 may rotate, based on the suction mode of the air purifier 100 being identified as in the basic suction mode, the plurality of blades 120 by 90°. In addition, the processor 130 may rotate, based on the suction mode of the air purifier 100 being identified as in the right suction mode, the plurality of blades 120 by θ₁°. Here, θ₁ may be greater than 0 and less than 90 (0<θ₁<90; for example, θ₁=45). In addition, the processor 130 may rotate, based on the suction mode of the air purifier 100 being identified as in the left suction mode, the plurality of blades 120 by θ₂°. Here, θ₂ may be greater than 90 and less than 180 (90<θ₂<180; for example, θ₂=135). In addition, the processor 130 may rotate, based on the suction mode of the air purifier 100 being identified as in the left and right suction mode, the portion of the blades 121 by θ₁°, and the remaining blades 122 by θ₂°. Here, θ₁ may be greater than 0 and less than 90 (0<θ₁<90; for example, θ₁=45), and θ₂ may be greater than 90 and less than 180 (90<θ₂<180; for example, θ₂=135). In addition, the processor 130 may rotate, based on the suction mode of the air purifier 100 being identified as in the swing suction mode, the plurality of blades 120 in the left and right directions.

Specifically, the processor 130 may identify, based on an object being identified as not present (i.e. absent) in the surrounding of the air purifier 100 based on the operation state of the air purifier 100, that the suction mode of the air purifier 100 is in the basic suction mode, and rotate the plurality of blades by 90° according to the basic suction mode.

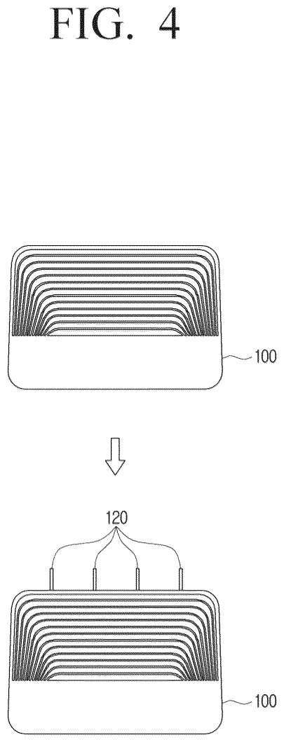

For example, as in FIG. 4, the processor 130 may drive, based on an object being identified as not present in the surrounding of the air purifier 100, the air purifier 100 in the basic suction mode, and rotate the plurality of blades 120 by 90°. Accordingly, the air purifier 100 may suction indoor air while the plurality of blades 120 is rotated by 90°.

In addition, the processor 130 may control, based on the air purifier 100 being identified as present in a same surrounding environment as a previous surrounding environment based on the operation state of the air purifier 100, the air purifier 100 to operate a same suction mode as the previous suction mode of the air purifier.

That is, the processor 130 may identify, based on the air purifier 100 being identified as present in the same environment as previously, that the suction mode of the air purifier 100 is in a suction mode that the air purifier 100 previously operated. To this end, information about the suction mode that the air purifier 100 operated prior to being turned-off may be stored in the memory. That is, the processor 130 may store information about the suction mode of the air purifier 100 in the memory. For example, the processor 130 may store information about whether the suction mode of the air purifier 100 has been changed, or the suction modes of the air purifier 100 at pre-set time intervals in the memory.

For example, as in FIG. 5A, if a wall is present at the right side of the air purifier 100, a user may set the suction mode of the air purifier 100 in the left suction mode for an effective purification of indoor air. Then, if the surrounding environment of the air purifier 100 has not changed, the wall may still be present at the right side of the air purifier 100. In this case, the processor 130 may drive, based on the surrounding environment of the air purifier 100 being identified as not having been changed, the air purifier 100 in the left suction mode, and rotate the plurality of blades 120 by θ₂°. Accordingly, the air purifier 100 may suction indoor air in a state in which a direction of the plurality of openings formed by the plurality of blades 120 is facing the left direction.

For example, as in FIG. 5B, if a wall is present at a rear direction of the air purifier 100, the user may set the suction mode of the air purifier 100 in the left and right suction mode for an effective purification of indoor air. Then, if the surrounding environment of the air purifier 100 has not changed, the wall may still be present at the rear direction of the air purifier 100. In this case, the processor 130 may drive, based on the surrounding environment of the air purifier 100 being identified as not having been changed, the air purifier 100 in the left and right suction mode, and rotate the portion of the blades 121 by θ₁°, and the remaining blades 122 by θ₂°. Accordingly, the air purifier 100 may suction indoor air, due to the driving of the fan 110, in a state in which a portion of the openings is facing the right direction, and the remaining openings are facing the left direction from among the plurality of openings formed by the plurality of blades 120.

In addition, the processor 130 may control, based on an object being identified as present in the surrounding of the air purifier 100 based on the operation state of the air purifier, the air purifier 100 to operate in each of the plurality of suction modes, and identify the power consumption of the motor that drives the fan 110 while the air purifier 100 is being driven in each of the plurality of suction modes.

Here, the plurality of suction modes may include the right suction mode, the left suction mode, the left and right suction mode, and the swing suction mode.

In this case, the processor 130 may drive the air purifier 100 for a pre-set time for each of the suction modes.

For example, the processor 130 may measure the power consumption of the motor while driving the air purifier 100 in the right suction mode for 1 minute, measure the power consumption of the motor while driving the air purifier 100 in the left suction mode for 1 minute, measure the power consumption of the motor while driving the air purifier 100 in the left and right suction mode for 1 minute, and measure the power consumption of the motor while driving the air purifier 100 in the swing suction mode for 1 minute.

Then, the processor 130 may identify that the suction mode with the lowest power consumption from among the plurality of suction modes is the suction mode of the air purifier 100 based on the identified power consumption, and control the plurality of blades 120 based on the identified suction mode.

For example, as in FIG. 6, it may be assumed that the air purifier 100 that had no objects present nearby is moved, and a wall is present at the rear direction of the air purifier 100. The processor 130 may drive, based on an object being identified as present in the surrounding of the air purifier 100, the air purifier 100 according to the right suction mode, the left suction mode, the left and right suction mode, and the swing suction mode, and identify the power consumption of the motor that drives the fan 110 from each suction mode. At this time, if the power consumption of the motor in the left and right suction mode is the lowest, the processor 130 may control the air purifier 100 to operate in the swing suction mode, and rotate the plurality of blades 120 left and right.

That is, the rotation angle of the plurality of blades 120 may be determined according to the suction mode, and accordingly, the direction from which the air is suctioned may be determined. At this time, if suction resistance is present in the direction from which air is suctioned, the power consumption of the motor may be increased. Accordingly, the processor 130 may estimate, based on an object being identified as present in the surrounding of the air purifier 100, the position of suction resistance by driving the air purifier 100 in the right suction mode, the left suction mode, the left and right suction mode, and the swing suction mode, and determine the suction mode of the air purifier 100 taking into consideration the position of suction resistance. Accordingly, the indoor air may be effectively purified.

In addition, the processor 130 may provide, based on an object being identified as present in the surrounding of the air purifier 100, a notification for indicating that the object is present in the surrounding of the air purifier 100.

For example, the processor 130 may display a user interface (UI) including notifications such as “Suction resistance is present in the surrounding of the air purifier 100.” or “Suction resistance is present in the surrounding of the air purifier 100. If the air purifier 100 is moved to another position, indoor air may be more effectively purified.” in a display of the air purifier 100. In addition, the processor 130 may output a text of the above in voice form through a speaker of the air purifier 100.

In the above-described example, the air purifier 100 has been described as identifying the surrounding environment of the air purifier 100 by comparing information about measured operation states at a previous time-point and a current time-point.

However, the above is merely one example, and the processor 130 may identify the surrounding environment of the air purifier 100 by comparing information about the operation states measured at a pre-set value and the current time-point.

Here, the pre-set value may include a rotation speed of the fan 110, and power consumption and input current of the motor measured with no object present in the surrounding of the air purifier 100, and the pre-set value may be measured at a manufacturing step of the air purifier 100 and stored in the memory of the air purifier 100.

Specifically, the processor 130 may identify, based on the rate of change of the current rotation speed with respect to a pre-set rotation speed being less than or equal to a first value, that an object is present in the surrounding of the air purifier 100, and identify, based on the rate of change of the current rotation speed with respect to the pre-set rotation speed being greater than the first value, that the object is not present in the surrounding of the air purifier 100.

In addition, the processor 130 may identify, based on the rate of change of the current power consumption with respect to a pre-set power consumption being less than or equal to a second value, that an object is not present in the surrounding of the air purifier 100, and identify, based on the rate of change of the current power consumption with respect to the pre-set power consumption being greater than the second value, that an object is present in the surrounding of the air purifier 100.

In addition, the processor 130 may identify, based on a rate of change of a current input current with respect to a pre-set input current being less than or equal to a second value, that an object is not present in the surrounding of the air purifier 100, and identify, based on the rate of change of the current input current with respect to the pre-set input current being greater than the second value, that an object is present in the surrounding of the air purifier 100.

In the above-described examples, the first value may be 95%, and the second value may be 105%. However, the above is one example, and the first and second values may be various values.

In addition, in the above-described example, the suction mode of the air purifier 100 has been described as being automatically set according to the surrounding environment of the air purifier 100. In addition, the suction mode of the air purifier 100 may be set according to a user input.

For example, modes of the air purifier 100 may include a mode for setting the suction mode of the air purifier 100 based on a user input (e.g., a manual mode) and a mode for automatically setting the suction mode of the air purifier 100 (e.g., an automatic mode). Here, the manual mode and the automatic mode may be set according to a user input.

The processor 130 may receive, based on the mode of the air purifier 100 being in the manual mode, a user input for selecting the suction mode of the air purifier 100. Then, the processor 130 may control the plurality of blades 120 based on the suction mode selected according to the user input. The processor 130 may automatically set, based on the mode of the air purifier 100 being in the automatic mode, the suction mode of the air purifier 100 based on the surrounding environment of the air purifier 100 as described above.

In addition, the processor 130 has been described as identifying the surrounding environment of the air purifier 100 based on the operation state of the air purifier 100 in the above-described example.

Furthermore, the processor 130 may identify whether an object is present in the surrounding of the air purifier 100 based on information obtained through the sensor, and set, based on the object being identified as present, the suction mode of the air purifier 100 as one from among the plurality of suction modes. To this end, the air purifier 100 may include a sensor for sensing a distance between the air purifier 100 and an object present in the surrounding of the air purifier 100. Here, the sensor may include a LiDAR sensor, an ultrasonic sensor, and the like.

Specifically, the processor 130 may identify a distance between the air purifier 100 and an object in the surrounding of the air purifier 100 using the sensor, and identify, based on the identified distance being less than or equal to a pre-set distance, that an object is present in the surrounding of the air purifier 100. Here, the pre-set distance may be 300 mm. However, the above is one example, and the pre-set distance may have various values.

Further, the processor 130 may identify, based on the object being identified as present in the surrounding of the air purifier 100, the suction mode of the air purifier 100 based on a direction at which the object is present, and control for the air purifier 100 to operate in the identified suction mode.

For example, the processor 130 may identify, based on an object being identified as present at the left side of the air purifier 100, that the suction mode of the air purifier 100 is in the right suction mode. In addition, the processor 130 may identify, based on an object being identified as present at the right side of the air purifier 100, that the suction mode of the air purifier 100 is in the left suction mode. In addition, the processor 130 may identify, based on an object being identified as present at the rear direction of the air purifier 100, that the suction mode of the air purifier 100 is in the left and right suction mode or the swing suction mode.

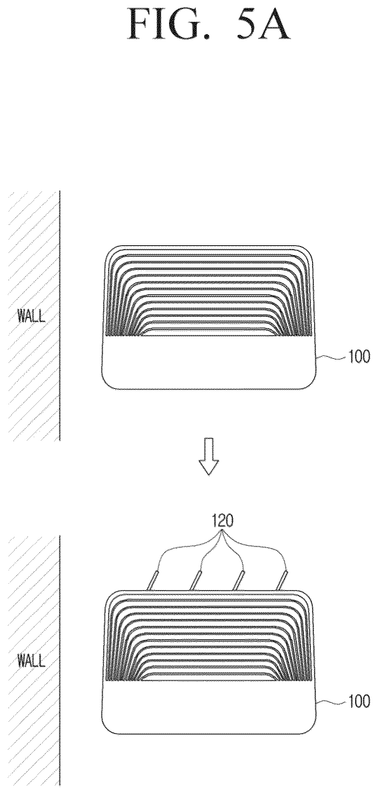

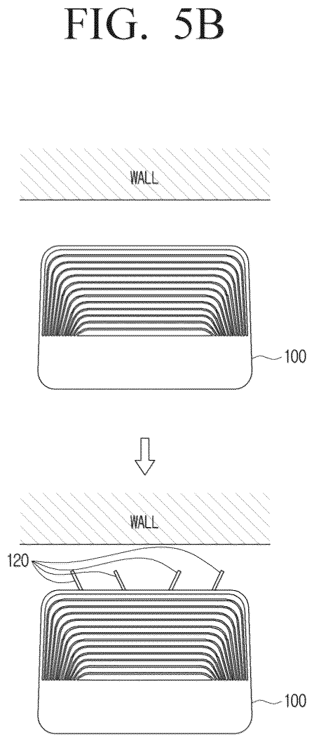

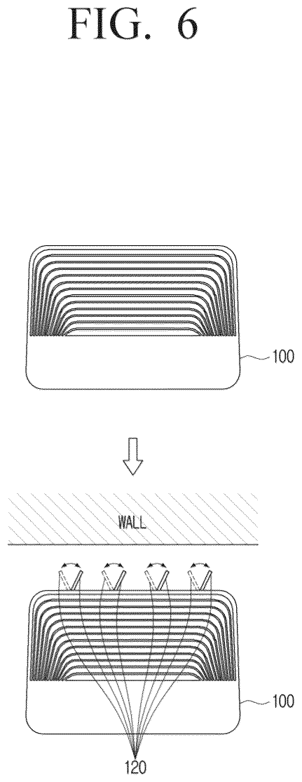

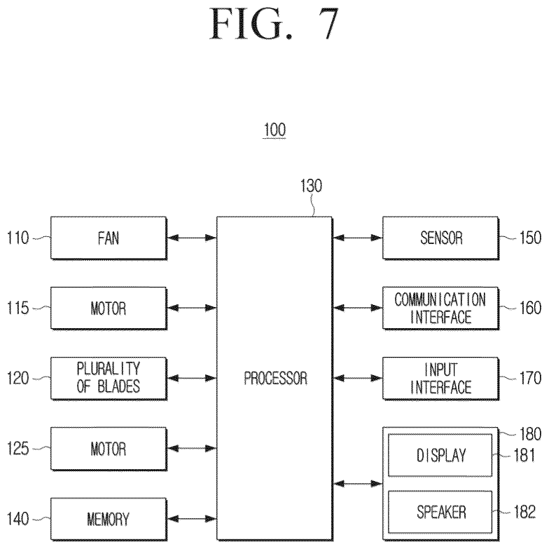

FIG. 7 is a block diagram illustrating a detailed configuration of an air purifier according to various embodiments of the disclosure.

Referring to FIG. 7, the air purifier 100 may include the fan 110, a motor 115, the plurality of blades 120, a motor 125, the processor 130, a memory 140, a sensor 150, a communication interface 160, an input interface 170, and an output interface 180. However, configurations described above are merely examples, and new configurations may be added or a portion of the configurations may be omitted in addition to the configurations described in implementing the disclosure. However, in describing FIG. 7, parts that overlap with the parts described in FIG. 1 to FIG. 6 may be omitted or described in brief.

The motor 115 may be a motor for driving the fan 110. In this case, the processor 130 may rotate, based on the user input for driving the air purifier 100 (e.g., user input for turning-on the air purifier 100) being received, the fan 110 by controlling the motor 115. In addition, the processor 130 may stop, based on receiving a user input for turning-off the air purifier 100 that is being driven, the rotation of the fan 110 by controlling the motor 115.

The motor 125 may be a motor for rotating the plurality of blades 120. In this case, the motor 125 may include a plurality of motors. In this case, the processor 130 may rotate the plurality of blades 120 by controlling the motor 125 according to the suction mode of the air purifier 100.

The memory 140 may store various data associated with the operations and functions of the air purifier 100. For example, information about the previous operation state of the air purifier 100, and information about the suction mode operated by the air purifier 100 may be stored in the memory 140.

In addition, at least one instruction associated with the air purifier 100 may be stored in the memory 140. Further, various software programs or applications for operating the air purifier 100 according to various embodiments of the disclosure may be stored in the memory 140. In addition, various software modules for operating the air purifier 100 according to various embodiments of the disclosure may be stored in the memory 140, and the processor 130 may control an operation of the air purifier 100 by executing various software modules stored in the memory 140.

In this case, the memory 140 may include a volatile memory such as a frame buffer, a semiconductor memory such as a flash memory, a magnetic storage medium such as a hard disk, or the like.

The sensor 150 may sense the surrounding environment of the air purifier 100. For example, the sensor 150 may include a LiDAR sensor, an ultrasonic sensor, and the like. In this case, the processor 130 may identify a distance between the air purifier 100 and an object in the surrounding of the air purifier 100 using the sensor 150.

The communication interface 160 may include circuitry. The communication interface 160 may be a configuration that performs communication with an external device. The processor 130 may transmit various data to the external device through the communication interface 160, and receive various data from the external device. For example, the processor 130 may receive data corresponding to a user input for controlling an operation of the air purifier 100 through the communication interface 160. To this end, the communication interface 160 may perform communication with the external device through wireless communication methods such as, for example, and without limitation, Bluetooth (BT), Bluetooth Low Energy (BLE), Wireless Fidelity (WI-FI), and the like.

The input interface 170 may receive a user input. To this end, the input interface 170 may include a plurality of buttons. In addition, the input interface 170 may be implemented as a touch screen capable of simultaneously performing a function of a display 181. Further, the input interface 170 may transmit the input user input to the processor 130.

In this case, the processor 130 may control, based on a user input being received through the communication interface 160 and the input interface 170, an operation of the air purifier 100 based on the received user input.

For example, the processor 130 may drive the fan 110 if a user input for turning-on the power of the air purifier 100 is received. Then, the processor 130 may identify the suction mode of the air purifier 100 according to the surrounding environment of the air purifier 100, and automatically control the plurality of blades 120 according to the suction mode.

In addition, the processor 130 may receive a user input for setting the mode of the air purifier 100 in the manual mode. In this case, the processor 130 may set the mode of the air purifier 100 in the manual mode. Then, the processor 130 may identify, based on a user input for selecting the suction mode of the air purifier 100 being received, the suction mode of the air purifier 100 based on the user input, and control the plurality of blades 120 according to the suction mode.

In addition, the processor 130 may receive a user input for setting the mode of the air purifier 100 in the automatic mode. In this case, the processor 130 may set the mode of the air purifier 100 in the automatic mode. Then, the processor 130 may identify the suction mode of the air purifier 100 according to the surrounding environment of the air purifier 100, and automatically control the plurality of blades 120 according to the suction mode.

In addition, the processor 130 may stop, based on a user input for turning-off power of the air purifier 100 being received, the driving of the fan 110, and close the plurality of blades 120.

As described, the processor 130 may control an operation of the air purifier 100 according to various user inputs.

The output interface 180 may include the display 181 and a speaker 182.

The display 181 may display various information. To this end, the display 181 may be implemented as a liquid crystal display (LCD). Specifically, the processor 130 may display information associated with an operation of the air purifier 100 in the display 181. For example, the processor 130 may display information about a suction mode of the air purifier 100 in the display 181. In addition, the processor 130 may display a notification indicating that an object is present in the surrounding of the air purifier 100 in the display 181.

The speaker 182 may output audio. Specifically, the processor 130 may output various notification sounds or voice guide messages associated with an operation of the air purifier 100 through the speaker 182. For example, the processor 130 may output a voice guide message about a suction mode of the air purifier 100 through the speaker 182. In addition, the processor 130 may output a voice guide message indicating that an object is present in the surrounding of the air purifier 100 through the speaker 182.

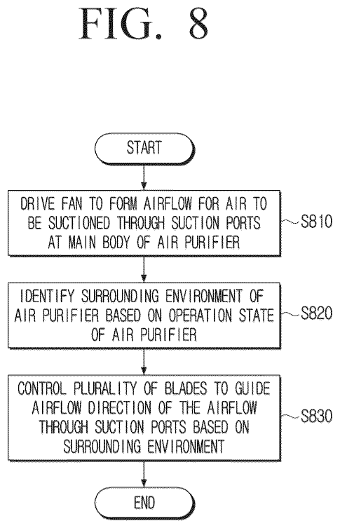

FIG. 8 is a flowchart illustrating an air suction method of an air purifier according to various embodiments of the disclosure.

First, the fan may be driven to form an airflow for air to be suctioned through the suction port formed at the main body of the air purifier (S810).

Then, the surrounding environment of the air purifier may be identified based on the operation state of the air purifier (S820).

Then, the plurality of blades may be controlled to guide the air flow direction of the airflow that being suctioned through the suction port based on the identified surrounding environment (S830).

Here, the operation state of the air purifier may include at least one from among the rotation speed of the fan, the power consumption of the motor that drives the fan, and the input current of the motor.

In this case, in operation S820, the surrounding environment of the air purifier may be identified based on the rate of change of the current operation state of the air purifier with respect to the previous operation state of the air purifier.

Specifically, in operation S820, if the rate of change of the current rotation speed with respect to the previous rotation speed of the fan is less than or equal to a first value, an object may be identified as present in the surrounding of the air purifier, and if the rate of change of the current rotation speed with respect to the previous rotation speed of the fan is greater than the first value and less than or equal to a second value, the air purifier may be identified as present in the same environment as previously, and if the rate of change of the current rotation speed with respect to the previous rotation speed of the fan is greater than the second value, the object may be identified as not present in the surrounding of the air purifier.

In addition, in operation S820, if the rate of change of the current power consumption with respect to the previous power consumption of the motor is less than or equal to a first value, an object may be identified as not present in the surrounding of the air purifier, and if the rate of change of the current power consumption with respect to the previous power consumption of the motor is greater than the first value and less than or equal to a second value, the air purifier may be identified as present in the same environment as previously, and if the rate of change of the current power consumption with respect to the previous power consumption of the motor is greater than the second value, the object may be identified as present in the surrounding of the air purifier.

In addition, in operation S820, if the rate of change of the current input current with respect to the previous input current of the motor is less than or equal to a first value, an object may be identified as not present in the surrounding of the air purifier, and if the rate of change of the current input current with respect to the previous input current of the motor is greater than the first value and less than or equal to a second value, the air purifier may be identified as present in the same environment as previously, and if the rate of change of the current input current with respect to the previous input current of the motor is greater than the second value, the object may be identified as present in the surrounding of the air purifier.

In operation S830, the suction mode of the air purifier may be identified as one suction mode from among the plurality of suction modes based on the identified surrounding environment, and the plurality of blades may be controlled based on the identified suction mode. In this case, the rotation angle of the plurality of blades may be determined according to the suction mode of the air purifier.

In this case, in operation S830, if an object is identified as not present in the surrounding of the air purifier based on the operation state of the air purifier, the suction mode of the air purifier may be identified as the basic suction mode, and the plurality of blades may be rotated by 90° according to the basic suction mode.

In addition, in operation S830, if the air purifier is identified as present in the same environment as previously based on the operation state of the air purifier, the air purifier may be driven in the same suction mode as the previous suction mode of the air purifier.

In addition, in operation S830, if an object is identified as present in the surrounding of the air purifier based on the operation state of the air purifier, the air purifier may be driven in each of the plurality of suction modes, the power consumption of the motor that drives the fan may be identified while the air purifier is being driven in each of the plurality of suction modes, the suction mode with the lowest power consumption from among the plurality of suction modes may be identified as the suction mode of the air purifier based on the identified power consumption, and the plurality of blades may be controlled based on the identified suction mode. In this case, the plurality of suction modes may include the left suction mode, the right suction mode, the left and right suction mode, and the swing suction mode.

The specific method in which the air purifier controls the plurality of blades according to the suction mode has been described above.

With respect to operation S820 in FIG. 8, in the above-described example, the air purifier 100 has been described as comparing the current operation state of the air purifier 100 with the previous operation state of the air purifier 100, and identifying the surrounding environment.

However, according to an example, the operation state of the air purifier 100 may include the current operation state of the air purifier 100. That is, the air purifier 100 may identify the surrounding environment using the current operation state of the air purifier 100, and control the plurality of blades 120 based on the identified surrounding environment, but the above will be described in greater detail below with reference to FIG. 9.

Referring to FIG. 9, the processor 130 may drive the air purifier 100 in each of the plurality of suction modes (S910).

Here, the plurality of suction modes may include the basic suction mode, the right suction mode, the left suction mode, the left and right suction mode, and the swing suction mode.

In this case, the processor 130 may drive the air purifier 100 for a pre-set time for each of the suction modes. For example, the pre-set time may be 1 minute. However, the above is one example, and embodiments are not limited to this example.

For example, the processor 130 may drive, based on a user input for turning-on power of the air purifier 100 being received, the air purifier 100 for 1 minute in the basic suction mode, drive the air purifier 100 for 1 minute in the right suction mode, drive the air purifier 100 for 1 minute in the left suction mode, drive the air purifier 100 for 1 minute in the left and right suction mode, and drive the air purifier 100 for 1 minute in the swing suction mode.

Further, the processor 130 may identify the operation state of the air purifier 100 while the air purifier 100 is being driven in each of the suction modes (S920).

Here, the operation state of the air purifier 100 may be the power consumption of the motor for driving the fan 110. That is, the processor 130 may measure the power consumption of the motor while the air purifier 100 is being driven in each of the basic suction mode, the right suction mode, the left suction mode, the left and right suction mode, and the swing suction mode.

Then, the processor 130 may identify the surrounding environment of the air purifier 100 based on the identified operation state of the air purifier 100 (S930).

As described above, the rotation angle of the plurality of blades 120 may be determined according to the suction mode, and accordingly, the direction at which air is suctioned may be determined. At this time, if suction resistance is present in the direction at which the air is suctioned, the power consumption of the motor may increase.

Accordingly, the processor 130 may identify the surrounding environment of the air purifier 100 using the power consumptions of the motor measured from each of the plurality of suction modes.

Specifically, the processor 130 may identify the suction mode with the lowest power consumption from among the power consumptions of the motor measured from each of the plurality of suction modes. Then, the processor 130 may identify that suction resistance exerted by an object is the smallest in the suction mode with the lowest power consumption.

Further, the processor 130 may determine the suction mode of the air purifier 100 with the suction mode with the lowest power consumption, and drive the air purifier 100 according to the determined suction mode.

For example, the processor 130 may rotate, based on the suction mode with the lowest power consumption being the left suction mode, the plurality of blades 120 by θ₂°. Accordingly, the air purifier 100 may suction indoor air in a state in which the direction of the plurality of openings formed by the plurality of blades 120 is facing the left direction.

As described, the processor 130 may estimate the position of suction resistance by driving the air purifier 100 in the basic suction mode, the right suction mode, the left suction mode, the left and right suction mode, and the swing suction mode, and the suction mode of the air purifier 100 may be determined taking into consideration the position of suction resistance.

The processor 130 may identify the operation state of the air purifier 100 while the air purifier 100 is being driven in each of the plurality of suction modes, and provide a notification based on the identified operation state.

That is, the power consumptions of the motor measured from each of the plurality of suction modes being greater than a threshold value may be that objects are present at not only the back surface side of the air purifier 100 at which the suction port 11 is positioned, but also at the left side and the right side of the air purifier 100, and in this case, the objects may act as suction resistances, and efficiency of the air purifier 100 may be lowered. Accordingly, the processor 130 may provide, based on the power consumptions of the motor measured from each of the plurality of suction modes being greater than the threshold value, a notification to guide position movements of the air purifier 100.

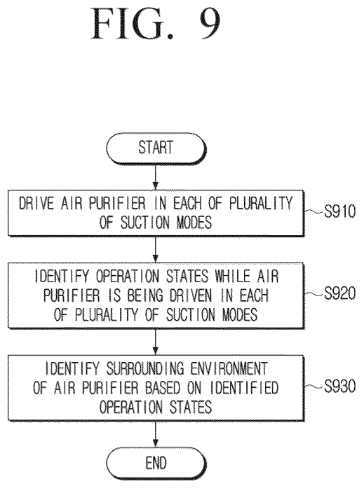

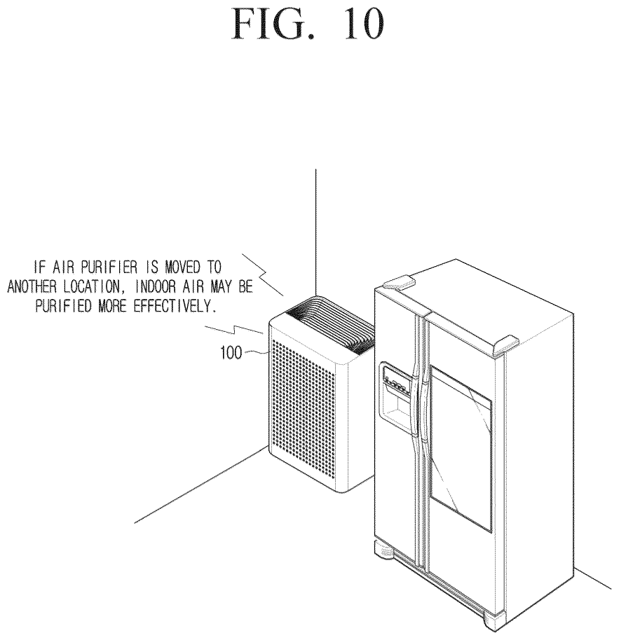

For example, as in FIG. 10, the processor 130 may display a UI including notifications such as “Suction resistance is present in the surrounding of the air purifier 100. If the air purifier 100 is moved to another position, indoor air may be more effectively purified” in the display 181. In addition, the processor 130 may output the text as described in voice form through the speaker 182.

According to various embodiments, a method according to the embodiments of the disclosure may be provided included a computer program product. The computer program product may be exchanged between a seller and a purchaser as a commodity. The computer program product may be distributed in a form of a machine-readable storage medium (e.g., a compact disc read only memory (CD-ROM)), or distributed online (e.g., downloaded or uploaded) through an application store (e.g., PLAYSTORE™) or directly between two user devices (e.g., smartphones). In the case of online distribution, at least a portion of the computer program product (e.g., downloadable app) may be stored at least temporarily in the machine-readable storage medium such as a server of a manufacturer, a server of an application store, or a memory of a relay server, or temporarily generated.

Each of the elements (e.g., a module or a program) according to the various embodiments of the disclosure as described in the above may be configured as a single entity or a plurality of entities, and a portion of sub-elements of the above-mentioned sub-elements may be omitted, or other sub-elements may be further included in the various embodiments. Alternatively or additionally, a portion of the elements (e.g., modules or programs) may be integrated into one entity to perform the same or similar functions performed by the respective elements prior to integration.

Operations performed by a module, a program, or another element, in accordance with the various embodiments, may be executed sequentially, in a parallel, repetitively, or in a heuristic manner, or at least a portion of the operations may be executed in a different order, omitted or a different operation may be added.

The term “part” or “module” used in the disclosure may include a unit configured with hardware, software, or firmware, and may be used interchangeably with terms such as, for example, and without limitation, logic, logic blocks, components, circuits, or the like. “Part” or “module” may be a component integrally formed or a minimum unit or a part of the component performing one or more functions. For example, a module may be configured with an application-specific integrated circuit (ASIC).

A non-transitory computer-readable medium stored with a program that sequentially performs the air suction method according to the disclosure may be provided. The non-transitory computer-readable medium may refer to a medium that stores data semi-permanently rather than storing data for a very short time, such as a register, a cache, a memory, or the like, and is readable by a device. Specifically, the above-described various applications or programs may be provided stored in the non-transitory computer-readable medium such as, for example, and without limitation, a compact disc (CD), a digital versatile disc (DVD), a hard disc, a Blu-ray disc, a USB, a memory card, a read only memory (ROM), and the like.

In addition, various embodiments of the disclosure may be implemented with software including instructions stored in a machine-readable storage media (e.g., computer). The machine may call a stored instruction from a storage medium, and as a device operable according to the called instruction, may include an electronic device (e.g., air purifier (100)) according to the above-mentioned embodiments.

Based on the instruction being executed by the processor, the processor may directly or using other elements under the control of the processor perform a function corresponding to the command. The instruction may include a code generated by a compiler or executed by an interpreter.

While the disclosure has been illustrated and described with reference to one or more embodiments, it will be understood that the one or more embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiments described herein may be used in conjunction with any other embodiments described herein.

What is claimed is:

1. An air purifier comprising:
a main body comprising a suction port;
a fan in the main body and configured to form a flow of air for the air to be suctioned through the suction port;
a plurality of blades coupled to the main body and configured to guide an air flow direction of the air suctioned through the suction port; and
one or more processors configured to:
identify a surrounding environment of the air purifier based on an operation state of the air purifier, and
control the plurality of blades based on the surrounding environment.

2. The air purifier of claim 1, further comprising a motor configured to drive the fan,
wherein the operation state of the air purifier comprises at least one of a rotation speed of the fan, a power consumption of the motor, or an input current of the motor.

3. The air purifier of claim 2, wherein the one or more processors are further configured to identify the surrounding environment of the air purifier based on a rate of change of a current operation state of the air purifier with respect to a previous operation state of the air purifier.

4. The air purifier of claim 3, wherein the one or more processors are further configured to:
based on a rate of change of a current rotation speed with respect to a previous rotation speed of the fan being less than or equal to a first value, identify that an object is present in the surrounding environment of the air purifier,
based on the rate of change of the current rotation speed with respect to the previous rotation speed of the fan being greater than the first value and less than or equal to a second value, identify that the air purifier is present in a same surrounding environment as a previous surrounding environment, and
based on the rate of change of the current rotation speed with respect to the previous rotation speed of the fan being greater than the second value, identify that the object is absent in the surrounding environment of the air purifier.

5. The air purifier of claim 3, wherein the one or more processors are further configured to:
based on a rate of change of a current power consumption with respect to a previous power consumption of the motor being less than or equal to a first value, identify that an object is absent in the surrounding environment of the air purifier,
based on the rate of change of the current power consumption with respect to the previous power consumption of the motor being greater than the first value and less than or equal to a second value, identify that the air purifier is present in a same surrounding environment as a previous surrounding environment; and
based on the rate of change of the current power consumption with respect to the previous power consumption of the motor being greater than the second value, identify that the object is present in the surrounding environment of the air purifier.

6. The air purifier of claim 3, wherein the one or more processors are further configured to:
based on a rate of change of a current input current with respect to a previous input current of the motor being less than or equal to a first value, identify that an object is absent in the surrounding environment of the air purifier;
based on the rate of change of the current input current with respect to the previous input current of the motor being greater than the first value and less than or equal to a second value, identify that the air purifier is present in a same surrounding environment as a previous surrounding environment; and
based on the rate of change of the current input current with respect to the previous input current of the motor being greater than the second value, identify that the object is present in the surrounding environment of the air purifier.

7. The air purifier of claim 1, wherein the one or more processors are further configured to:
identify a suction mode of the air purifier among a plurality of suction modes based on the surrounding environment, and
control the plurality of blades based on the identified suction mode, and
wherein a rotation angle of the plurality of blades is based on the suction mode of the air purifier.

8. The air purifier of claim 7, wherein the one or more processors are further configured to:
based on an object being identified as not present in the surrounding environment of the air purifier based on the operation state of the air purifier, identify that the suction mode of the air purifier is a basic suction mode, and
rotate the plurality of blades by 90° based on the basic suction mode.

9. The air purifier of claim 7, wherein the one or more processors are further configured to:
based on the air purifier being identified as present in a same surrounding environment as a previous surrounding environment based on the operation state of the air purifier, control the air purifier to operate a same suction mode as a previous suction mode of the air purifier.

10. The air purifier of claim 7, wherein the one or more processors are further configured to:
based on an object being identified as present in a surrounding environment of the air purifier based on the operation state of the air purifier, control the air purifier to operate in each of the plurality of suction modes,
identify a power consumption of a motor that drives the fan while the air purifier is being driven in each of the plurality of suction modes,
identify a suction mode having a lowest power consumption from among the plurality of suction modes as the suction mode of the air purifier based on the identified power consumption, and
control the plurality of blades based on the identified suction mode, and
wherein the plurality of suction modes comprise a left suction mode, a right suction mode, a left and right suction mode, and a swing suction mode.

11. An air suction method of an air purifier, the method comprising:
driving a fan to form an airflow for air to be suctioned through a suction port at a main body of the air purifier;
identifying a surrounding environment of the air purifier based on an operation state of the air purifier; and
controlling a plurality of blades to guide an air flow direction of the airflow through the suction port based on the surrounding environment.

12. The method of claim 11, wherein the operation state of the air purifier comprises at least one of a rotation speed of the fan, a power consumption of a motor that drives the fan, or an input current of the motor.

13. The method of claim 12, wherein the identifying the surrounding environment of the air purifier comprises identifying the surrounding environment of the air purifier based on a rate of change of a current operation state of the air purifier with respect to a previous operation state of the air purifier.

14. The method of claim 13, wherein the identifying the surrounding environment of the air purifier comprises:
identifying, based on a rate of change of a current rotation speed with respect to a previous rotation speed of the fan being less than or equal to a first value, that an object is present in the surrounding environment of the air purifier;
identifying, based on the rate of change of the current rotation speed with respect to the previous rotation speed of the fan being greater than the first value and less than or equal to a second value, that the air purifier is present in a same surrounding environment as a previous surrounding environment; and
identifying, based on the rate of change of the current rotation speed with respect to the previous rotation speed of the fan being greater than the second value, that the object is not present in the surrounding of the air purifier.

15. The method of claim 13, wherein the identifying the surrounding environment of the air purifier comprises:
identifying, based on a rate of change of a current power consumption with respect to a previous power consumption of the motor being less than or equal to a first value, that an object is not present in a surrounding of the air purifier;
identifying, based on the rate of change of the current power consumption with respect to the previous power consumption of the motor being greater than the first value and less than or equal to a second value, that the air purifier is present in a same surrounding environment as a previous surrounding environment; and
identifying, based on the rate of change of the current power consumption with respect to the previous power consumption of the motor being greater than the second value, that the object is present in the surrounding environment of the air purifier.

16. The method of claim 13, wherein the identifying the surrounding environment of the air purifier comprises:
based on a rate of change of a current input current with respect to a previous input current of the motor being less than or equal to a first value, identifying that an object is absent in the surrounding environment of the air purifier;
based on the rate of change of the current input current with respect to the previous input current of the motor being greater than the first value and less than or equal to a second value, identifying that the air purifier is present in a same surrounding environment as a previous surrounding environment; and
based on the rate of change of the current input current with respect to the previous input current of the motor being greater than the second value, identifying that the object is present in the surrounding environment of the air purifier.

17. The method of claim 11, wherein
the controlling the plurality of blades comprises:
identifying a suction mode of the air purifier among a plurality of suction modes based on the surrounding environment, and
controlling the plurality of blades based on the identified suction mode, and
wherein a rotation angle of the plurality of blades is based on the suction mode of the air purifier.

18. The method of claim 17, wherein
the controlling the plurality of blades comprises:
based on an object being identified as not present in the surrounding environment of the air purifier based on the operation state of the air purifier, identifying that the suction mode of the air purifier is a basic suction mode, and
rotating the plurality of blades by 90° based on the basic suction mode.

19. The method of claim 17, wherein
the controlling the plurality of blades comprises:
based on the air purifier being identified as present in a same surrounding environment as a previous surrounding environment based on the operation state of the air purifier, controlling the air purifier to operate a same suction mode as a previous suction mode of the air purifier.

20. A non-transitory computer readable recording medium storing computer instructions that cause an air purifier to perform an operation when executed by one or more processors of the air purifier, wherein the operation comprises;
driving a fan to form an airflow for air to be suctioned through a suction port at a main body of the air purifier;
identifying a surrounding environment of the air purifier based on an operation state of the air purifier; and
controlling a plurality of blades to guide an air flow direction of the airflow through the suction port based on the surrounding environment.
